(19) United States
(12) Patent Application Publication
(10) Pub. No.: US 2026/0091750 A1
(43) Pub. Date: Apr. 2, 2026

(54) RESTRAINING STRAP DEVICE AND USE THEREOF

(71) Applicant: Straehle + Hess GmbH, Althengstett (DE)

(72) Inventors: David Wiedenroth, Reutlingen (DE); Armin Fendt, Bad Reichenhall (DE)

(21) Appl. No.: 19/355,020

(22) Filed: Oct. 10, 2025

Related U.S. Application Data
(63) Continuation of application No. PCT/EP2024/062057, filed on May 2, 2024.

(30) Foreign Application Priority Data
May 10, 2023 (DE) 10 2023 112 362.9

(51) Int. Cl. B60R 21/216

(52) U.S. Cl. CPC B60R 21/216

(57) ABSTRACT

A restraining strap device for retaining a cladding element in an interior of a motor vehicle when an airbag is triggered is provided. The restraining strap device connects the cladding element to a structural element of the motor vehicle, and comprises a strap and two insert parts that are arranged at the two opposite ends of the strap. End portions of the strap are folded around in a direction of the center of the strap such that an insert part is received between two layers of the strap. Recesses are provided in the two layers of the strap and the insert part. The recesses lie above one another such that in each case a connection element is guidable through the two layers of the strap and the insert part in order to connect the respective end of the restraining strap device to the cladding element or the structural element.

### CROSS-REFERENCE TO RELATED APPLICATIONS

This application is a continuation of international application number PCT/EP2024/062057 filed on May 2, 2024 and claims the benefit of German application number 10 2023 112 362.9 filed on May 10, 2023, which are incorporated herein by reference in their entirety and for all purposes.

### BACKGROUND OF THE INVENTION

The present invention relates to a restraining strap device for retaining a cladding element in the interior region of a motor vehicle when an airbag is triggered, wherein the restraining strap device is provided for the purpose of connecting the cladding element to a structural element of the motor vehicle.

Further, the invention relates to the use of a restraining strap device of this kind for retaining a cladding element in the interior region of a motor vehicle when an airbag is triggered.

In modern motor vehicles, comprehensive airbag systems are frequently installed in order to protect the occupants from injury in the event of an accident. In this context, individual airbags are arranged in particular in the head region of the occupants and are in each case installed behind a cladding element in the interior region of the motor vehicle, that is to say for example behind the roof liner, a side cladding, a door cladding, a dashboard, etc.

When the airbag is triggered and unfolds, the relevant cladding element is forcibly deformed and possibly detached from its original position. A problem here is the risk that the occupants are adversely affected or even injured by a deformed or detached cladding element.

### SUMMARY OF THE INVENTION

To solve this problem, the invention proposes a restraining strap device of the type mentioned in the introduction, wherein the restraining strap device comprises a strap and two insert parts that are arranged at the two opposite ends of the strap, wherein in each case an end portion of the strap at its opposite ends is folded around in the direction of the center of the strap such that an insert part is received between two layers of the strap, and wherein in each case there are provided in the two layers of the strap and in the insert part recesses which lie substantially congruently above one another such that in each case a connection element is guidable through the two layers of the strap and the insert part in order to connect the respective end of the restraining strap device to the cladding element or the structural element.

As a result of the restraining strap device according to the invention, it is possible to prevent the occupants from undergoing adverse effects and injuries caused by a deformed or detached cladding element in that the length of the strap is selected such that the cladding element cannot reach the occupants. At the same time, because of its construction the restraining strap device takes up little space in the initial condition, with the result that installation is possible without problems even when there is little spacing between the cladding element and the structural element.

In the context of the present invention, “of cladding element in the interior region” are all types of cladding elements which are oriented toward the interior, that is to say in particular the passenger compartment of a motor vehicle. Typical examples of such cladding elements are the roof liner, side cladding, pillar cladding, door cladding, armrests, dashboards and steering column cladding.

In the context of the present invention, the “structural elements of a motor vehicle” are in particular the body parts and all the elements which are connected in a load-bearing manner to the body vehicle and which are thus suitable for fixing cladding elements using the restraining strap device according to the invention.

Because the restraining strap device according to the invention is secured to the cladding element and the structural element by separate connection elements, it is very flexible to use, that is to say fundamentally the same restraining strap device (where appropriate of different lengths) can be used for different cladding elements of a motor vehicle and different motor vehicle models. Where necessary, adaptation to the installation position is possible by a selection of the connection element, wherein it is frequently also possible to use standardized connection elements that are fundamentally known in the automotive sector. By combining different insert parts and straps, the restraining strap device according to the invention is moreover assemblable at low cost.

Particularly advantageously, the restraining strap device according to the invention may be assembled and supplied with two connection elements already guided through the recesses at the two ends of the restraining strap device. The connection elements have a cross section corresponding to the recesses. This simplifies and speeds up installation of the restraining strap device that is provided with the connection elements.

The connection elements that are used for assembly of the restraining strap device according to the invention are preferably configured such that they make a latching connection respectively with the cladding element or the structural element. This latching connection can no longer be detached by pulling forces on the connection element, with the result that the cladding element is securely fixed to the structural element.

Fundamentally, the strap of the restraining strap device according to the invention may be any flat, flexible structure that has the required tensile strength. In a preferred embodiment of the invention, the strap is formed from a textile material, in particular a webbing, a warp knitted fabric, a weft knitted fabric, a roving fabric, or a combination thereof. Here, the strap may either be manufactured from yarns or fibers to have the final dimensions, or be assembled from a textile material of larger dimensions. The use of a webbing strap for example is particularly advantageous.

The strap of the restraining strap device according to the invention is preferably manufactured from a synthetic fiber material. Straps of this kind are able to take up very high tensile forces. In particular, the strap may be made from polyester fibers or polyamide fibers.

The width, thickness and material of the strap may be varied depending on the respective requirements, in particular in order to ensure sufficient tensile strength of the strap. Further, the strap should also have the smallest possible elongation.

The dimensions of the strap may be selected depending on the respective installation position, wherein the width of the strap in particular also corresponds to the dimensions of the connection elements and the recesses needed for this. Further, the width of the strap also depends on the required tensile strength. Typically, the strap has a length of approximately 150 to approximately 350 mm, preferably approximately 200 to approximately 300 mm, and/or a width of approximately 15 to approximately 35 mm, preferably approximately 20 to approximately 30 mm. Here, the length refers to the total length of the strap before the end portions are folded around.

The folded-around end portions of the strap preferably each have a length of approximately 25 to approximately 50 mm. In each case, the end portions should be sufficiently large with regard to the recesses provided therein. Preferably, the end portions are respectively folded around onto opposite sides of the strap.

Favorably, the layers of the strap that are formed when the end portions are folded around are connected to one another by sewing, ultrasonic welding, gluing or riveting. Particularly preferably, the layers are connected to one another by sewing, that is to say by a seam, in particular in the case of a strap made from a textile material. The seam must be located in a region in which there is no insert part arranged between the two layers, in particular in the region of the folded-around end portions that is oriented toward the center of the strap. The dimension of the insert parts in the longitudinal direction of the restraining strap device is thus preferably smaller than the length of the folded-around end portions.

The seam may be made using a yarn of a color different from the color of the strap (such as a red seam on a black strap). This makes it easier to see that the seam is present and correctly arranged.

Favorably, the insert parts of the restraining strap device according to the invention take the form of flat parts, preferably made from a plastics material or a metal material. Plastics are frequently preferred because of the lower costs and lighter weight. A range of different plastics materials may be used, such as polyamide or polyoxymethylene (POM). Such insert parts may be manufactured in particular by injection molding or by 3D printing. Where insert parts are made from metal, in particular steel may be used, such as spring steel.

The insert parts preferably have a thickness of approximately 0.7 to approximately 4 mm, more preferably approximately 1 to approximately 2 mm. The possibility of making the insert parts and hence the restraining strap device as a whole with a very low thickness and overall height produces various advantages.

On the one hand, the use of a flat insert part generally enables the restraining strap device according to the invention to take a flat and compact overall shape. The relatively small dimension of the insert parts relative to the length of the strap also contributes to this, with the result that the restraining strap device is flexible over a large part of its length. The result, as already mentioned above, is that the restraining strap device takes up less space in the intermediate space between the relevant cladding element and the structural element of the motor vehicle. This is also and particularly true by comparison with known restraining straps, in which a securing element is integrally formed at one or both ends of a webbing strap by overmolding the webbing strap with a plastics material. Such securing elements do not only have a greater thickness, but are more complex to manufacture. Moreover, when the webbing strap is overmolded, it is necessary to take into account the compatibility of the plastics material of the securing element and the fiber material of the webbing strap, whereas in the case of the restraining strap device according to the invention the materials of the strap and the insert parts are selectable entirely independently of one another (even though using the same material may be desirable for other reasons, such as from the point of view of recycling).

With the restraining strap device according to the invention, secure fixing of the ends of the strap respectively to the cladding element and the structural element is fundamentally achieved independently of the insert parts. However, the insert parts provide the advantage that the connection elements can be received in the recesses in the insert parts with positive engagement and substantially free of play before the restraining strap device is mounted in the motor vehicle. The connection elements are also secured in a manner preventing rotation in the recesses in the insert parts.

In the simplest case, the insert parts may take a substantially rectangular form and be entirely received between the two layers of the strap. In a preferred embodiment of the invention, however, it is provided for the insert parts each to have a central part, which is received between the two layers of the strap, and two side parts, which adjoin the central part in the width direction of the strap and are angled in the same direction with respect to the central part, preferably by approximately 20° to approximately 60°, more preferably by approximately 35° to approximately 45° (angle between the side part and the plane of the central part). By a suitable selection of the material and thickness of the insert parts, the angled side parts have a certain flexibility, with the result that the insert parts can be received without play in a mounting gap, compensating for dimensional tolerances. The width and angle of the side parts are thus selected depending on the mounting gap. As a result, rattling in the event of vibration can be prevented. This is also an advantage over securing elements that are manufactured by overmolding the ends of the webbing strap.

The side parts of the insert parts preferably each have a width of approximately 20% to approximately 40% of the width of the central part. The thickness of the side parts may be equal to or less than the thickness of the central part.

It is favorable if the central part of the insert part, which is received between the two layers of the strap, tapers in the longitudinal direction toward the center of the strap, wherein a seam that connects the two layers to one another is also formed to the side of the tapering portion of the central part. This prevents the insert part from being displaced in the width direction of the strap even if the connection element has not yet been guided through the recesses. The asymmetric shape of the central part in relation to the longitudinal direction of the strap is also advantageous in that it prevents the insert part from being inadvertently inserted in the wrong orientation (that is to say with the taper pointing toward the end of the strap) when the restraining strap is manufactured.

As a result of giving the central part an asymmetric shape, it is moreover also possible to prevent a wrong orientation of the restraining strap when it is fixed to a structural element of the motor vehicle. For this, the relevant point is that the central part extends further, starting from the aperture, toward the center of the strap than toward the end of the strap (disregarding tapering). In a corresponding installation position, the lengthened portion of the central part is then “in the way” if the attempt is made to install the strap in the wrong orientation.

The recesses in the layers of the strap and in the insert part may take a substantially rectangular form, and preferably have a width of approximately 20% to approximately 50% of the width of the strap, more preferably approximately 30% to approximately 40%. In all cases, the regions of the strap remaining next to the recesses should be wide enough to ensure the required tensile strength.

As already mentioned, the shape of the recesses corresponds in particular to the cross sectional shape of the connection elements. The recesses may have for example notches at opposite sides in order to enable latching elements of the connection elements to be guided through the recesses.

The recesses in the layers of the strap are preferably wider than the recesses in the insert part, preferably by approximately 10% to approximately 35%. This makes it possible, in the case of a strap made from a textile material, to prevent fibers of the strap from projecting into the recess in the insert part and possibly having a hindering effect as the connection element is guided through.

Further, the present invention relates to the use of a restraining strap device according to the invention for retaining a cladding element in the interior region of a motor vehicle when an airbag is triggered. Here, the one end of the restraining strap device is connected to the cladding element by a connection element, and the other end of the restraining strap device is connected to a structural element of the motor vehicle by a connection element. The structural element is preferably a body part of the motor vehicle.

Particular advantages and preferred embodiments of the use according to the invention were already explained in conjunction with the restraining strap device according to the invention.

The cladding element is in particular a roof liner, a side cladding, a pillar cladding, a door cladding, an armrest, a dashboard or a steering column cladding of a motor vehicle.

### BRIEF DESCRIPTION OF THE DRAWINGS

These and further advantages of the invention are explained in more detail using the exemplary embodiment below, with reference to the drawing.

In detail:

FIG. 1 shows a strap for a restraining strap device according to the invention, in plan view;

FIG. 2 shows an insert part for a restraining strap device according to the invention, in plan view and in side view; and

FIG. 3 shows a restraining strap device according to the invention, in plan view and in side view.

### DETAILED DESCRIPTION OF THE INVENTION

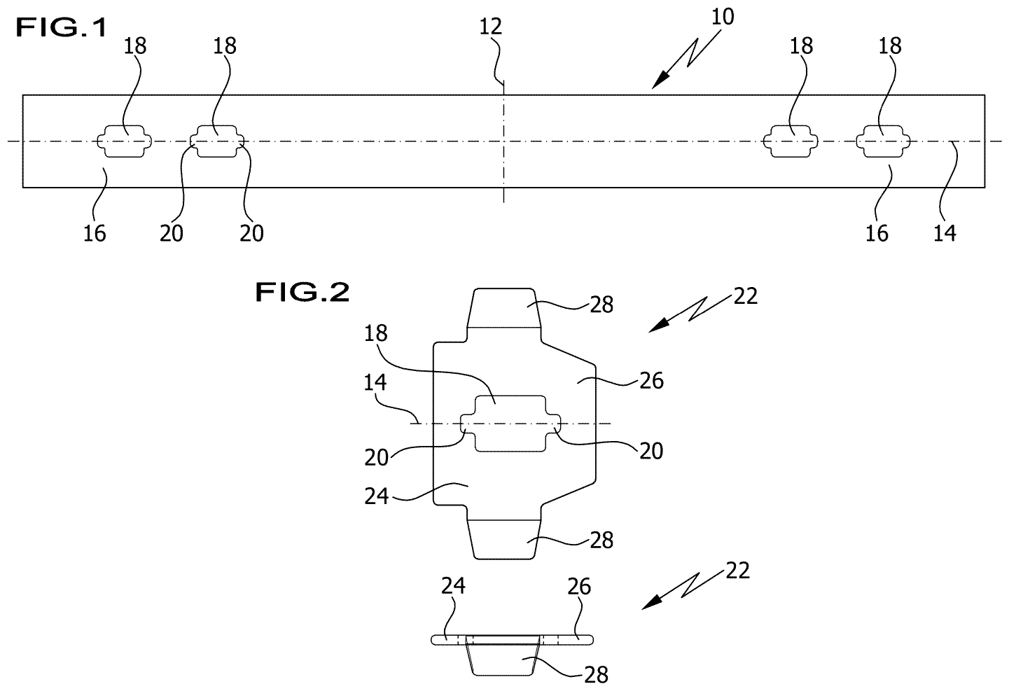

FIG. 1 diagrammatically shows, in plan view, a strap 10 for manufacturing a restraining strap device according to the invention. The strap 10 takes a mirror-symmetrical form in respect of a center axis 12 and a longitudinal axis 14. Preferably, the strap 10 is a webbing strap 10 manufactured from a synthetic fiber material such as polyester fibers.

At its two end portions 16, the webbing strap 10 has in each case a recess 18 and in each case a further recess 18 offset in the direction of the center axis 12. All the recesses 18 have the same shape, namely a substantially rectangular shape with notches 20 along the longitudinal axis 14, at opposite sides of the recesses 18. The recesses 18 may favorably be made in the webbing strap 10 by laser machining. This achieves as exact a contour as possible for the recesses 18 and largely prevents fraying of the webbing strap 10.

FIG. 2 diagrammatically shows an insert part 22 as a constituent part of a restraining strap device according to the invention. The insert part 22 is manufactured as a flat part from a plastics material such as polyamide. The insert part 22 may have a thickness of for example approximately 1.3 mm.

The insert part 22 comprises a central part 24, of which the width is slightly smaller than the width of the webbing strap 10 according to FIG. 1. To one side, the central part 24 has a tapering portion 26.

Further, the insert part 22 has two side parts 28 that adjoin the central part 24 in the width direction and are angled in the same direction with respect to the central part 24, for example by approximately 40°.

Formed in the central part 24 of the insert part 22 is a recess 18, which has the same shape as the recesses 18 in the webbing strap 10 according to FIG. 1, and has the same orientation in relation to the longitudinal axis 14. However, the recess 18 in the insert part 22 is slightly smaller than the recesses 18 in the webbing strap 10.

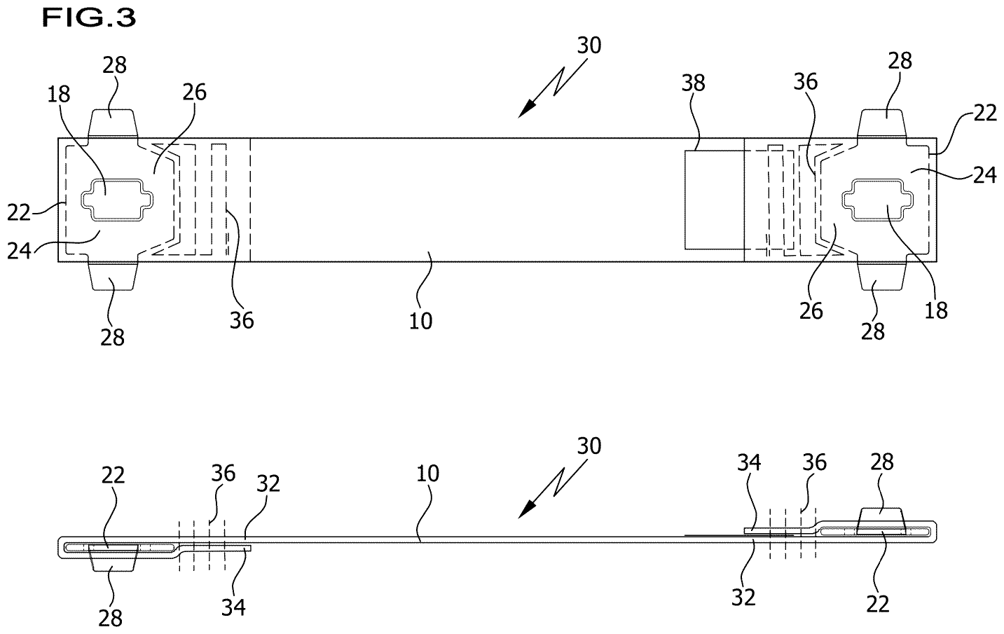

FIG. 3 diagrammatically shows, in plan view and in side view, an exemplary embodiment of a restraining strap device 30 according to the invention, which is manufactured from the webbing strap 10 according to FIG. 1 and two insert parts 22 according to FIG. 2.

The end portions 16 of the webbing strap 10 are respectively folded around the insert parts 22 in the direction of the center axis 12 such that the tapering portions 26 of the insert parts 22 are oriented toward the center axis 12, and such that the recesses 18 in the webbing strap 10 and the insert part 22 respectively lie congruently above one another. The layers 32 and 34 of the webbing strap 10 that are formed during the folding around are connected to one another by a seam 36 such that the insert part 22 is securely received between the layers 32 and 34 and cannot be removed. In particular, the seam 36 also runs to the side of the tapering portions 26 of the insert parts 22.

Additionally, there may also be secured to the restraining strap device 30 by the seam 36 a label 38, which may contain various information on the restraining strap device, such as a part number, instructions for installation, and similar.

In the exemplary embodiment according to FIG. 3, the side parts 28 of the two insert parts 22 point in different directions in respect of the plane of the webbing strap 10. Depending on the installation position of the restraining strap device 30, however, all the side parts 28 may also point in the same direction. Likewise, the two end portions 16 of the webbing strap 10 may be folded around onto different sides, as shown in FIG. 3, or to the same side.

During use of the restraining strap device 30, typically at first two connection elements (not illustrated) are guided through the recesses 18, wherein the cross sectional shape of the connection elements corresponds to the shape of the recesses 18, with the result that the connection elements are held with positive engagement in the recesses 18 in the insert parts 22. The restraining strap device 30, which is pre-assembled with the two connection elements, may then in a simple manner be mounted in the motor vehicle by connecting one connection element to the relevant cladding element (such as a roof liner) and the other connection element to a relevant body part (such as a roof pillar) in the manner provided for. Corresponding connection elements are known to those skilled in the art in the automotive sector.

The fact that the cladding element is connected to the body part by way of the restraining strap device according to the invention prevents the cladding element from being moved too far into the vehicle interior as a result of deformation or detachment in the event that an airbag is triggered.

As a result, adverse effects or injury to the passengers by the deformed or detached cladding element can be avoided.

### LIST OF REFERENCE NUMERALS

10 (Webbing) strap
12 Center axis
14 Longitudinal axis
16 End portions
18 Recesses
20 Notches
22 Insert part
24 Central part
26 Tapering portion
28 Side parts
30 Restraining strap device
32 First layer
34 Second layer
36 Seam
38 Label

What is claimed is:

1. A restraining strap device for retaining a cladding element in the interior region of a motor vehicle when an airbag is triggered, wherein the restraining strap device is provided for the purpose of connecting the cladding element to a structural element of the motor vehicle, wherein the restraining strap device comprises a strap and two insert parts that are arranged at the two opposite ends of the strap, wherein in each case an end portion of the strap at its opposite ends is folded around in the direction of the center of the strap such that an insert part is received between two layers of the strap, and wherein in each case there are provided in the two layers of the strap and in the insert part recesses which lie substantially congruently above one another such that in each case a connection element is guidable through the two layers of the strap and the insert part in order to connect the respective end of the restraining strap device to the cladding element or the structural element.

2. The restraining strap device as claimed in claim 1, wherein the strap is formed from a textile material selected from a webbing, a warp knitted fabric, a weft knitted fabric, a roving fabric, or a combination thereof.

3. The restraining strap device as claimed in claim 2, wherein the strap is manufactured from a synthetic fiber material.

4. The restraining strap device as claimed in claim 1, wherein at least one of: the strap has a length of approximately 150 to approximately 350 mm; and the strap has a width of approximately 15 to approximately 35 mm.

5. The restraining strap device as claimed in claim 1, wherein the folded-around end portions of the strap each have a length of approximately 25 to approximately 50 mm.

6. The restraining strap device as claimed in claim 1, wherein the end portions are respectively folded around onto opposite sides of the strap.

7. The restraining strap device as claimed in claim 1, wherein the layers of the strap that are formed when the end portions are folded around are connected to one another by sewing, ultrasonic welding, gluing or riveting.

8. The restraining strap device as claimed in claim 1, wherein the insert parts take the form of flat parts made from a plastics material or a metal material.

9. The restraining strap device as claimed in claim 1, wherein the insert parts have a thickness of approximately 0.7 to approximately 4 mm.

10. The restraining strap device as claimed in claim 1, wherein the insert parts each have a central part, which is received between the two layers of the strap, and two side parts, which adjoin the central part in the width direction of the strap and are angled in the same direction with respect to the central part.

11. The restraining strap device as claimed in claim 10, wherein the side parts each have a width of approximately 20% to approximately 40% of the width of the central part.

12. The restraining strap device as claimed in claim 1, wherein the central part of the insert part, which is received between the two layers of the strap, tapers in the longitudinal direction toward the center of the strap, and wherein a seam that connects the two layers to one another is also formed to the side of the tapering portion of the central part.

13. The restraining strap device as claimed in claim 1, wherein the recesses in the layers of the strap and in the insert parts take a substantially rectangular form, and have a width of approximately 20% to approximately 50% of the width of the strap.

14. The restraining strap device as claimed in claim 1, wherein the recesses in the layers of the strap are wider than the recesses in the insert part by approximately 10% to approximately 35%.

15. The restraining strap device as claimed in claim 1, wherein the one end of the restraining strap device is connected to the cladding element by a connection element, and the other end of the restraining strap device is connected to a structural element of the motor vehicle by a connection element.

16. The restraining strap device as claimed in claim 15, wherein the cladding element is a roof liner, a side cladding, a pillar cladding, a door cladding, an armrest, a dashboard or a steering column cladding of a motor vehicle.
